(19) United States
(12) Patent Application Publication
(10) Pub. No.: US 2024/0177892 A1
(43) Pub. Date: May 30, 2024

(54) RESISTOR AND MANUFACTURING METHOD OF RESISTOR

(71) Applicant: KOA Corporation, Nagano (JP)

(72) Inventors: Reina KANEKO, Nagano (JP); Tomofumi NOGUCHI, Nagano (JP); Yoichi SAKAI, Nagano (JP); Junpei YAMAMOTO, Nagano (JP); Tomoki IGUCHI, Nagano (JP)

(21) Appl. No.: 18/552,178

(22) PCT Filed: Mar. 16, 2022
(86) PCT No.: PCT/JP2022/011949

§ 371 Date: Sep. 24, 2023

(30) Foreign Application Priority Data
Mar. 25, 2021 (JP) 2021-051902

(51) Int. Cl. H01C 1/032; H01C 17/02; H01C 17/26

(52) U.S. Cl. CPC H01C 1/032; H01C 17/02; H01C 17/265

(57) ABSTRACT

Provided is a resistor provided with a resistance body and electrodes provided on the resistance body, and the resistance body has an oxide film on a surface.

### CROSS-REFERENCE TO RELATED APPLICATIONS

This application is the U.S. national stage of PCT/JP2022/011949 filed on Mar. 16, 2022, which claims priority of Japanese Patent Application No. JP 2021-051902 filed on Mar. 25, 2021, the contents of which are incorporated herein.

### TECHNICAL FIELD

The present disclosure relates to a resistor and a manufacturing method of the resistor.

### BACKGROUND

JP2002-057009A discloses a current sensing resistor. In the resistor, electrodes are bonded to respective end portions of a resistance body.

### SUMMARY

In this resistor, there is a risk in that solder or other contaminant adheres to the resistance body as the solder creeps up to the resistance body by flowing along the electrode when the resistance body is mounted, for example. Therefore, a protection film made of resin, etc. is used to prevent the adhesion of the solder or the other contaminant.

An object of the present disclosure is to protect a resistance body without using a resin protection film and to enable suppression of variation in characteristics.

A resistor of an aspect of the present disclosure is the resistor provided with a resistance body and electrodes provided on the resistance body, and the resistance body has an oxide film on a surface.

According to the aspect of the present disclosure, the resistance body has the oxide film on the surface. Therefore, for example, even if solder approaches the resistance body by flowing along the electrodes, the adhesion of the solder to the resistance body is suppressed by the oxide film.

In addition, even if the solder reaches the resistance body by flowing along the electrodes, the oxide film is interposed between the solder and the resistance body. With such a configuration, a direct contact between the solder and the resistance body is suppressed. Therefore, compared with a case in which the solder may flow beyond bonded positions between the resistance body and the electrodes and come into direct contact with the resistance body, it is possible to suppress variation in a resistance value.

As described above, the resistance body is protected by the surface oxide film. With such a configuration, it is possible to maintain the resistance characteristics over a long period of time.

### BRIEF DESCRIPTION OF DRAWINGS

FIG. 1 is a perspective view of the resistor of a first embodiment.

FIG. 2 is a sectional view of a main portion of the resistor of the first embodiment.

FIG. 3 is an explanatory diagram showing a manufacturing method of the resistor of the first embodiment.

FIG. 4 is an explanatory diagram showing the manufacturing method of the resistor of a second embodiment.

FIG. 5 is an explanatory diagram showing the manufacturing method of the resistor of a third embodiment.

FIG. 6 is an explanatory diagram showing the manufacturing method of the resistor of a forth embodiment.

FIG. 7 is a perspective view of the resistor of a fifth embodiment.

### DETAILED DESCRIPTION OF PREFERRED EMBODIMENTS

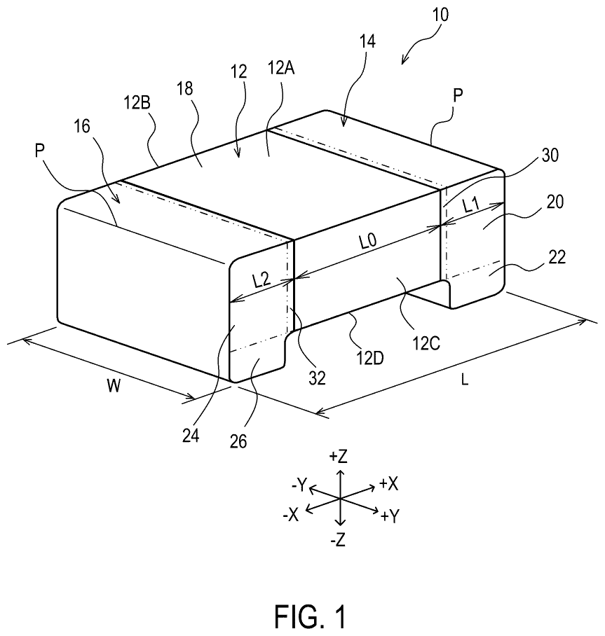

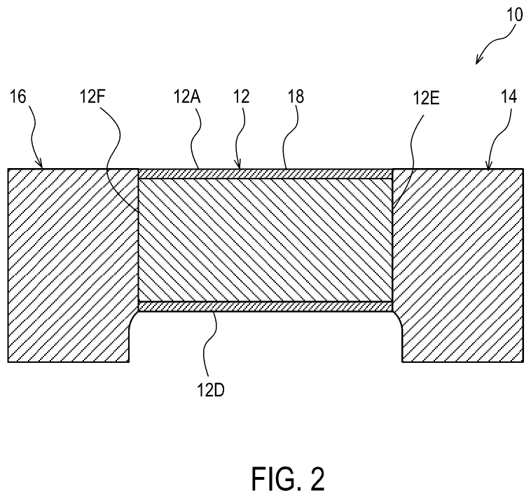

A resistor 10 of the first embodiment will be described in detail with reference to FIGS. 1 and 2. FIG. 1 is a perspective view of the resistor 10 of the first embodiment. FIG. 2 is a sectional view of a main portion of the resistor 10 of the first embodiment.

The resistor 10 is provided with a resistance body 12, a first electrode 14 that is provided on one end of the resistance body 12, and a second electrode 16 that is provided on the other end of the resistance body 12. In the resistor 10, the first electrode 14, the resistance body 12, and the second electrode 16 are bonded in this order.

The resistor 10 is mounted on a circuit board, etc., which is not shown in FIG. 1. For example, in the resistor 10, each of the electrodes 14 and 16 is connected to a land formed to have a wiring pattern on the circuit board by using solder. The resistor 10 described above is used as, as an example, a current sensing resistor (a shunt resistor).

Note that, in this embodiment, the direction in which the first electrode 14 and the second electrode 16 are aligned (the longitudinal direction of the resistor 10) is defined as the X direction, the direction towards the first electrode 14 is defined as the +X direction, and the direction towards the second electrode 16 is defined as the −X direction. In addition, the width direction of the resistor 10 is defined as the Y direction, the direction towards the front side of the paper plane of FIG. 1 is defined as the +Y direction, and the direction towards the rear side of the paper plane of FIG. 1 is defined as the −Y direction. Furthermore, the thickness direction of the resistor 10 is defined as the Z direction, the direction towards the circuit board is defined as the −Z direction, and the direction away from the circuit board is defined as the +Z direction. The X direction, the Y direction, and the Z direction are orthogonal with each other.

In addition, a mounting surface of the resistor 10 means a surface of the resistor 10 that faces the circuit board when the resistor 10 is mounted on the circuit board and that includes surfaces of the first electrode 14, the resistance body 12, and the second electrode 16 facing the circuit board.

The resistance body 12 is formed to have a cuboid shape (or a cube shape). The resistance body 12 has an oxide film 18 on its surfaces. Specifically, as shown in FIGS. 1 and 2, the oxide films 18 are respectively formed on an upper surface 12A, both side surfaces 12B and 12C, and a lower surface 12D of the resistance body 12, and thereby, the resistance body 12 is covered with the oxide film 18. In addition, the oxide films 18 are not provided on end surfaces 12E and 12F of the resistance body 12 to be bonded to the electrodes 14 and 16, respectively.

The resistance body 12 is configured by containing a metal for the resistance body. The metal for the resistance body includes manganese (Mn).

A resistance body material forming the resistance body 12 is defined in accordance with the application, and materials having a lower resistance to a higher resistance are used.

From the viewpoint of sensing a large current at a high accuracy, it is preferable that the resistance body 12 of this embodiment be formed of the resistance body material having a low specific resistance and a small temperature coefficient of resistance (TCR).

The resistance body material for forming the resistance body 12 will be described specifically. The resistance body material contains a copper (Cu) and the manganese (Mn). The resistance body material is formed of a Cu—Mn based alloy.

The surfaces of the resistance body 12 formed of the resistive material are subjected to a modification such that the oxide films 18 of manganese are respectively formed. The oxide film 18 contains manganese oxides such as MnO, Mn3O4 and so forth. It is preferable that the resistance body 12 does not have the oxide film 18 on bonded surfaces at which the resistance body 12 is bonded with respective electrodes 14 and 16.

The resistance body material contains 6 mass % or more and 35 ppm or less of manganese by the total mass ratio of the resistance body material. When the content of manganese is less than 6 mass % by the total mass ratio of the resistance body material, it is difficult to form the oxide film 18 of manganese, and there is a possibility that the oxide film 18 having a favorable thickness cannot be obtained.

In addition, when the content of manganese exceeds 35 mass %, the volume resistivity of the resulting resistance body material becomes higher than the required value. In addition, the resistance body material becomes harder and a processability thereof is deteriorated.

The resistance body material may contain, in addition to copper and manganese, aluminum, tin, nickel, chromium, and so forth.

The resistance body material is required to have a high versatility and to allow formation of the manganese oxide film with ease. In addition, the resistance body material is also required to be easy to design the volume resistivity and the temperature coefficient of resistance (TCR) to the required values. As the resistive material that satisfies these requirements, as an example of the resistance body material, a Cu—Mn—Sn based resistive material can be used.

The thickness of the oxide film 18 formed on the surface of the resistance body material may be equal to or greater than 70 nm.

The thickness of the oxide film 18 is not particularly limited, but when the thickness of the oxide film 18 is less than 70 nm, it becomes difficult to ensure a desired tolerance against a degradation of the resistance body surface of the resistance body 12 made of the resistance body material due to its use.

In addition, although there is no upper limit on the thickness of the oxide film 18, there is a risk of peeling depending on the thickness of the oxide film 18. Therefore, it is preferable that the thickness of the oxide film 18 does not exceed 2000 nm.

In addition, from the viewpoint of suppressing the influence of the formation of the oxide film 18 on the resistance-temperature characteristics of the resistive material, the thickness of the oxide film 18 is preferably 1% or less relative to the entire thickness of the resistance body material. By making the oxide film 18 to have a thin thickness, the temperature coefficient of resistance (TCR) of the resistance body material can be lowered so as to be 100 ppm/° C. or lower, for example, and the resistance body material can satisfy the characteristics as a fixed resistor.

With the resistance body material described above, because the oxide film 18 of manganese is formed on the surface of the resistance body material containing copper and manganese, it is possible to improve a heat resistance of the resistance body material. Thereby, it is possible to increase the upper limit of the usable temperature of the resistor 10 made of the resistance body material. Consequently, it is possible to increase the rated power of the resistor 10.

As shown in FIG. 1, the first electrode 14 includes a body portion 20 that is bonded to the resistance body 12 and a leg portion 22 that is formed integrally with the body portion 20 so as to extend towards the circuit board side. In addition, the second electrode 16 includes a body portion 24 that is bonded to the resistance body 12 and a leg portion 26 that is formed integrally with the body portion 24 so as to extend towards the circuit board side.

The first electrode 14 and the second electrode 16 are configured to contain a metal whose specific resistance is lower than that of the resistance body 12. From the viewpoint of ensuring stable sensing accuracy, the first electrode 14 and the second electrode 16 are formed of an electrically conductive material having favorable electrical conductivity and thermal conductivity.

For example, as the material for the first electrode 14 and the second electrode 16, copper (Cu), copper based alloy, and so forth may be used. Among copper, oxygen-free copper (C1020) is preferably used. The first electrode 14 and the second electrode 16 may be made of the same material from each other.

The body portion 20 of the first electrode 14 has an end surface having substantially the same shape as the end surface of the resistance body 12 on the +X direction side. The end surface of the body portion 20 of the first electrode 14 abuts against the end surface of the resistance body 12 on the +X direction side, and in this state, the end surface of the body portion 20 is bonded to the end surface of the resistance body 12.

The body portion 24 of the second electrode 16 has an end surface having substantially the same shape as the end surface of the resistance body 12 on the −X direction side. The end surface of the body portion 24 of the second electrode 16 abuts against the end surface of the resistance body 12 on the −X direction side, and in this state, the end surface of the body portion 24 is bonded to the end surface of the resistance body 12.

The leg portion 22 of the first electrode 14 extends towards the mounting surface of the resistor 10, in other words, the leg portion 22 extends in the −Z direction from the circuit board side of the body portion 20. The length of the leg portion 22 of the first electrode 14 in the X direction is shorter than the length of the body portion 20 in the X direction. A side surface of the leg portion 22 of the first electrode 14 on the +X direction side forms the same plane as a side surface of the body portion 20 on the +X direction side.

The leg portion 26 of the second electrode 16 extends towards the mounting surface of the resistor 10, in other words, the leg portion 26 extends in the −Z direction from the circuit board side of the body portion 24. The length of the leg portion 26 of the second electrode 16 in the X direction is shorter than the length of the body portion 24 in the X direction. A side surface of the leg portion 26 of the second electrode 16 on the −X direction side forms the same plane as a side surface of the body portion 24 on the −X direction side.

Bonding at a bonding portion between the resistance body 12 and the first electrode 14 and at a bonding portion between the resistance body 12 and the second electrode 16 is achieved by a welding, etc., and in addition, for example, the mutual bonding is achieved by a cladding (a solid phase bonding). In other words, the bonded surfaces are respectively a diffusion bonded surface in which metal atoms of the resistance body 12 and the first electrode 14 are diffused from each other and a diffusion bonded surface in which metal atoms of the resistance body 12 and the second electrode 16 are diffused from each other.

The resistor 10 is mounted on the circuit board such that the respective leg portions 22 and 26 project out towards the circuit board side. With such a configuration, the resistor 10 is mounted on the circuit board in a state in which the resistance body 12 is separated away from the circuit board.

A portion of the body portion 20 of the first electrode 14 that projects out towards the −X direction side is a projecting portion 30, and the projecting portion 30 is bonded to the resistance body 12. Similarly, a portion of the body portion 24 of the second electrode 16 that projects out towards the +X direction side is a projecting portion 32, and the projecting portion 32 is bonded to the resistance body 12.

In order to make the length L of the resistor 10 in the X direction (see FIG. 1) constant, the length of the projecting portion 30 in the X direction (the length L1 of the body portion 20, see FIG. 1) or the length of the projecting portion 32 in the X direction (the length L2 of the body portion 24 in the X direction, see FIG. 1) is adjusted arbitrarily. In this case, the length L0 of the resistance body 12 in the X direction (see FIG. 1) can be adjusted in accordance with L0=L−(L1+L2).

Therefore, it is possible to arbitrarily adjust the resistance value of the resistor 10 without changing the dimension L of the resistor 10 and without changing the shape of each of the leg portions 22 and 26. Alternatively, even if projected amount of each of the projecting portions 30 and 32 is increased without changing the dimension L of the resistor 10, because the distance between both of the leg portions 22 and 26 can be ensured, it is possible to increase a degree of freedom for designing the resistor 10 while ensuring a distance between the lands.

In the above, in the longitudinal direction of the resistance body 12 (the X direction), the ratio between the length L0 of the resistance body 12, the length L1 of the first electrode 14 in the X direction, and the length L2 of the second electrode 16 in the X direction may be set arbitrarily. However, from the viewpoint of making the resistance value smaller while suppressing the increase in the temperature coefficient of resistance (TCR), it is preferable that the ratio be L1:L0:L2=1:2:1, or close to 1:2:1.

Furthermore, from the viewpoint of increasing the heat dissipating characteristics and making the resistance value smaller, it is preferable that the proportion of the length L0 of the resistance body 12 to the length L of the resistor 10=(L1+L0+L2) be 50% or lower.

For example, the resistor 10 is formed such that the length L thereof in the X direction becomes 3.2 mm or shorter. In addition, for example, the resistance value of the resistor 10 is adjusted so as to be 2 mΩ or lower.

In addition, from the viewpoint of making the resistor 10 adaptable to a high density circuit board, the length L of the resistor 10 in the X direction can be set so as to be 3.2 mm or shorter, and the length (width) W of the resistor 10 in the Y direction can be set so as to be 1.6 mm or shorter (Product Standard 3216 size).

As the size of the resistor 10, the resistor 10 can also be applicable to Product Standard 2012 size (L: 2.0 mm, W: 1.2 mm), Product Standard 1608 size (L: 1.6 mm, W: 0.8 mm), and Product Standard 1005 size (L: 1.0 mm, W: 0.5 mm). With the resistor 10 having such a small size or even smaller size, a large advantage is achieved by the formation of a protection film according to this embodiment. However, this embodiment may be applied to a larger size.

From the viewpoint of ensuring the handling characteristics in a manufacturing method, which will be described below, for example, preventing breakage of a resistor base material serving as a base material of the resistor 10, the length L of the resistor 10 may be set to the size equal to or larger than the size for Product Standard 1005 size as described above.

From the viewpoint of realizing a small size and a low resistance, the resistance value of the resistor 10 can be adjusted so as to be 2 mΩ or lower in any of the size described above, and as an example, the resistance value may be adjusted so as to be 0.5 mΩ or lower. Here, the term “low resistance” refers to a concept including a resistance value that is lower than the resistance value that is expected based on the dimension of a general resistor (for example, a resistor of the type disclosed in JP2002-57009A).

All of corner portions P each serving as an edge of the resistor 10 extending in the Y direction have chamfered shapes. It is preferred that a radius of curvature of each of the corner portions P be set such that R=0.1 mm or smaller.

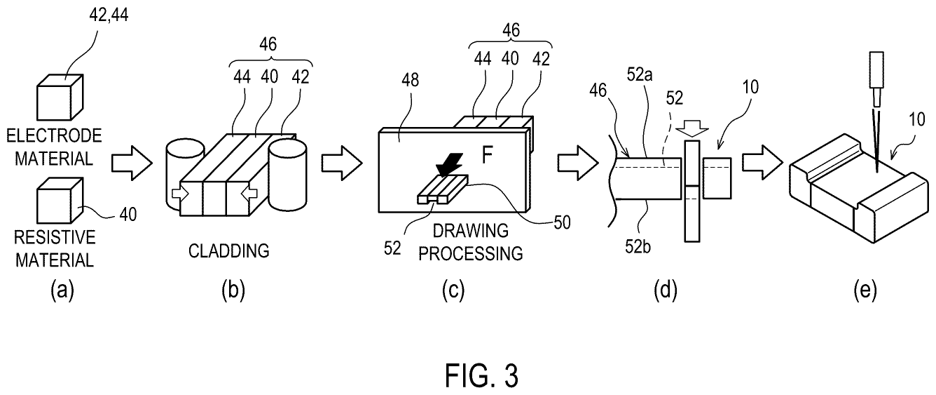

FIG. 3 is an explanatory diagram showing a manufacturing method of the resistor 10 of the first embodiment.

This manufacturing method includes a preparation step (a) in which a material is prepared, a bonding step (b) in which the material is bonded, and a processing step (c) in which a shape is processed. In addition, the manufacturing method includes a singulation step (d) in which the processed intermediate material is cut and singulated into individual resistor 10 and an adjusting step (e) in which the resistance value of the resistor 10 is adjusted by using a laser.

In the preparation step (a) of preparing the material, a resistance body base material 40 serving as a base material of the resistance body 12, an electrode body base material 42 serving as a base material of the first electrode 14, and an electrode body base material 44 serving as a base material of the second electrode 16 are prepared. The resistance body base material 40 and each of the electrode body base materials 42 and 44 are rectangular long wire materials.

From the viewpoint of the size, the resistance value, and the processability of the resistor 10, it is preferable to use the Cu—Mn based alloy as the resistance body base material 40 and to use oxygen-free copper (C1020) as the material for each of the electrode body base materials 42 and 44.

In the bonding step (b) of bonding the materials, the resistance body base material 40 is arranged between the electrode body base materials 42 and 44, and a resistor base material 46 is formed by bonding the base materials 40, 42, and 44 by applying a pressure in the arrangement direction of the base materials 40, 42, and 44.

In other words, in the bonding step (b), a so-called cladding (the solid phase bonding) between dissimilar metal materials is performed. The bonded surfaces formed by the cladding between the resistance body base material 40 and each of the electrode body base materials 42 and 44 are each a diffusion bonded surface into which metal atoms from both materials are diffused with each other.

Thus, it is possible to achieve firm mutual bonding at the bonded surface between the resistance body base material 40 and each of the electrode body base materials 42 and 44 without performing a common electron beam welding, etc. In addition, the good electrical characteristics are obtained at the bonded surface between the resistance body base material 40 and each of the electrode body base materials 42 and 44.

In the processing step (c), the resistor base material 46 obtained by the cladding is inserted into and passed through a through-hole 50 of a die 48.

The through-hole 50 of the die 48 is formed to have a tapered shape with a diameter that is reduced from an inlet towards an outlet. The through-hole 50 is formed to have a rectangular shape in which the corner portions are processed to have the chamfered shapes.

By passing the resistor base material 46 through the die 48 having such a shape, it is possible to compressively deform the resistor base material 46 from the all directions. By doing so, the cross-sectional shape of the resistor base material 46 is processed to the shape that imitates the cross-sectional shape of the through-hole 50 of the die 48.

In the processing step (c), when the resistor base material 46 is passed through the die 48, a drawing method in which the resistor base material 46 is drawn out by a holding tool is applied.

In the processing step (c), it may be possible to perform the drawing processing by preparing a plurality of dies 48 respectively having the through-holes 50 with different sizes and by passing the resistor base material 46 through the plurality of dies 48 in a consecutive manner.

On an inner surface of the through-hole 50 of the die 48, a rectangular projecting portion (not shown) is formed, and a rectangular groove 52 is formed in the resistor base material 46 being passed through the through-hole 50 by the projecting portion so as to be extended continuously in the drawing direction.

In a state in which the resistor base material 46 is cut into individual pieces, the rectangular groove 52 forms a recessed portion that is surrounded by the resistance body 12, the body portion 20 and the leg portion 22 of the first electrode 14, and the body portion 24 and the leg portion 26 of the second electrode 16.

In the singulation step (d), the resistor 10 is cut out from the resistor base material 46 so as to achieve the length W in the Y direction as designed.

In addition, in the singulation step (d), it is preferred that the resistor base material 46 be cut from a surface 52a of the resistor base material 46, in which the rectangular groove 52 is formed, towards an opposite surface 52b. By doing so, a burr of the metal is formed to have a shape that extends upwards from the upper surface of the resistor 10, and the burr extending in the −Z direction (the burr extending towards the circuit board) (see FIG. 1) is not formed on each of the leg portions 22 and 26. Thus, it is possible to surely perform mounting of the resistor 10 onto the circuit board.

By following the above-described steps, it is possible to obtain an individual piece of the resistor 10 from the resistor base material 46. Furthermore, in the adjusting step (e), the resistance value of the resistor 10 is set at a desired resistance value by performing the trimming of the resistance body 12 by irradiation of the laser.

Next, a heat treatment is performed on the resistor 10, which has been subjected to the trimming, to form the oxide film 18 on the surface of the resistance body 12. This heat treatment forms a forming step of forming the oxide film 18 on the surface of the resistance body 12. Note that the adjusting step (e) described above may be performed after the heat treatment.

Considering that the resistance value may be varied due to the heat treatment, it is suitable to perform a resistance value trimming after the heat treatment step. In this case, it is suitable because an oxide film of manganese is formed on the trimmed part that has been subjected to the laser irradiation. In the following, the heat treatment will be described specifically.

A step of forming the oxide film on the resistance body 12 of the resistor 10 according to this embodiment will be described.

In the heat treatment, it is intended to form the oxide film 18 on the resistance body 12 of the resistor 10. However, each of the electrodes 14 and 16 should not be oxidized. Therefore, the heat treatment is performed under a low oxygen concentration state.

In this step, the heat treatment is performed by placing, for a predetermined time, the resistor 10 having the resistance body 12 made of the resistance body material containing copper and manganese in a low oxygen atmosphere at a temperature at which the resistance body material can be oxidized.

For an electrode material and the resistance body material that are used in this embodiment, under a predetermined oxygen concentration condition, it has been found that the oxidation reaction of the resistance body material is preferentially advanced relative to the oxidation reaction of the electrode material.

In this embodiment, after application of vacuum, an atmosphere is purged with nitrogen, and thereby, a preferable oxygen concentration condition can be achieved.

Because the vacuumed state is a state filled with gasses at a lower atmospheric pressure than the normal atmospheric pressure, the oxygen concentration can be lowered. In addition, in a case in which the reaction system is purged with nitrogen, it is normally difficult to completely remove oxygen and replace it with nitrogen, and so, a certain amount of oxygen remains.

As described in this embodiment, in a case of the resistor 10 having the resistance body 12 made of the resistance body material containing copper and manganese, from the viewpoint of oxidizing the resistance body material, it is preferable to apply the nitrogen atmosphere in which the oxygen concentration is 5 ppm or more and 30 ppm or less.

In addition, the formation of the oxide film is considered to be dependent on a given amount of heat. Therefore, when a predetermined film thickness is to be achieved, the lower the temperature is, the longer the required time becomes, and the higher the temperature is, the shorter the required time becomes.

As described above, as an example, the temperature condition may be set from 400° C. or more and 800° C. or less, and the heat treatment time may be set 10 minutes or more and 300 minutes or less.

If the temperature condition of the heat treatment is lower than 400° C., for the resistance body made by using the resistance body material, it requires a long time to form the oxide film of manganese having the thickness capable of ensuring the desired tolerance against the degradation of the resistance body surface due to the use thereof.

In addition, if the temperature condition of the heat treatment exceeds 800° C., although the oxide film can be formed thick, the resistance body material may become soft, and the processability is deteriorated.

The time condition of the heat treatment can be 10 minutes or more and 300 minutes or less, depending on the temperature. At the same temperature, if the heat treatment time is short, it is not possible to form the film thickness capable of ensuring the desired tolerance against the degradation of the resistance body surface. In addition, if the heat treatment time exceeds 300 minutes, the oxide film becomes too thick, and the temperature coefficient of resistance (TCR) becomes higher than the required value.

Although the oxide film grows even when the temperature is 400° C. or lower, because the reaction time is increased, the difficulty of implementation is increased in practical terms. In addition, although the desired film thickness can be achieved within a shorter time when the temperature is 800° C. or higher, there is a risk in that deformation of the resistance body material is caused.

The terms “the temperature condition” and “the time condition” used in this embodiment are defined as below. The term “the temperature condition” indicates a temperature that is achieved by increasing the temperature at a predetermined increasing rate. The term “400° C. or more and 800° C. or less” for the temperature condition indicates this achieved temperature. In addition, the term “the time condition” indicates a period during which the achieved temperature is maintained. The term “10 minutes or more and 300 minutes or less” for the time condition of the heat treatment indicates this maintained time.

By performing the above-described heat treatment, it is possible to form the oxide film 18 of manganese having the thickness dimension of at least 70 nm on the surface of the resistance body 12. By providing the oxide film 18 of manganese, it is possible to improve the tolerance against the degradation of the surface of the resistance body 12.

As a method of improving the tolerance against the surface degradation of the resistance body 12, for example, a method of adding tin and/or aluminum, etc. in addition to copper and manganese to perform the heat treatment has been proposed. In this proposal, it is possible to form the oxide film of tin and/or aluminum on the surface of the resistance body 12.

However, in a case in which the resistance body 12 is made of the alloy containing tin and/or aluminum in addition to copper and manganese, tin and/or aluminum may form spots within the resistance body 12. In this case, under a situation in which an even higher temperature is required than before, there is a risk in that the resistance value becomes unstable, or cracks are caused in the spot portions due to difference in thermal stress, etc.

For such a problem, the present inventors focused on the oxide film, such as MnO, Mn3O4, MnO2, Mn2O3, and so forth, and repeatedly conducted extensive investigations. As a result of the extensive investigations, the present inventors have found that, among the above-described manganese oxide film, MnO and Mn3O4 particularly contribute to the prevention of the degradation of the resistance body 12, which appears as discoloration of the resistance body 12.

The oxide film 18 of manganese, which is a component of the resistance body 12, is formed on the surface of the resistance body 12. By doing so, compared with a case in which other metal(s), such as tin and/or aluminum, are/is added in addition to copper and manganese, it is possible to suppress the variation in the resistance value due to the degradation of the resistance body 12. In particular, in order to prevent the degradation of the resistance body 12, it is thought that it is important that MnO or Mn3O4 exists in the oxide film 18 of manganese.

Furthermore, with the oxide film 18 that is obtained by the manufacturing method of the resistor 10 according to this embodiment, not only the tolerance against the degradation of the surface of the resistance body 12, which is formed by using the resistance body material, is improved. Because the oxide film 18 is not stripped off even by bending or cutting of the resistance body 12 and is stable, there is an advantage in that a degree of freedom of plastic processing of the resistance body 12 can be increased.

Next, operational advantages achieved by this embodiment will be described.

According to the resistor 10 of this embodiment, there is provided the resistor 10 including the resistance body 12 and the electrodes 14 and 16 each provided on the resistance body 12, and the resistance body 12 has the oxide film 18 on the surface.

According to the above-described configuration, the resistance body 12 has the oxide film 18 on the surface. Therefore, even if the solder approaches the resistance body 12 by flowing along each of the electrodes 14 and 16, the adhesion of the solder to the resistance body 12 is suppressed by the oxide film 18.

Thus, it is possible to suppress, without covering the surface of the resistance body 12 with a resin, etc., a situation in which the solder comes to adhere directly to the resistance body 12.

In addition, even in a case in which the solder reaches the resistance body 12 by flowing along each of the electrodes 14 and 16, the oxide film 18 is interposed between the solder and the resistance body 12. With such a configuration, the direct connection between the solder and the resistance body 12 is suppressed. Therefore, compared with a case in which the solder may be directly connected to the resistance body at the side towards the center of the resistance body with respect to the bonding positions between the resistance body 12 and each of the electrodes 14 and 16, it is possible to suppress the variation in the resistance value.

Then, the resistance body 12 is protected by the surface oxide film 18. With such a configuration, because change in the characteristics is suppressed in the resistance body 12, it is possible to maintain the resistance characteristics over a long period of time.

Therefore, it is possible to protect the resistance body 12 without using the resin protection film and to suppress the variation in the characteristics.

In addition, in the resistor 10 of this embodiment, the resistance body 12 is configured so as to contain the metal for the resistance body, and each of the electrodes 14 and 16 is configured so as to contain the metal having a lower specific resistance than the resistance body 12.

In the resistor 10 of this embodiment, the metal for the resistance body contains manganese, and the oxide film 18 of manganese is formed on the surface of the resistance body 12.

With this configuration, the metal for the resistance body forming the resistance body 12 contains manganese. Therefore, as an example, by subjecting the resistance body 12 to the heat treatment, it is possible to form the oxide film 18. In addition, the oxide film 18 of manganese is formed on the surface of the resistance body 12. Therefore, the effect of suppressing the adhesion of the solder to the resistance body 12 is improved.

In addition, in the resistor 10 of this embodiment, the oxide film 18 contains MnO or Mn3O4.

With this configuration, the effect of suppressing the adhesion of the solder to the resistance body 12 is improved.

In addition, according to the resistor manufacturing method of this embodiment, there is provided the manufacturing method of the resistor 10 including the resistance body 12 and the electrodes 14 and 16 each provided on the resistance body 12, and the manufacturing method includes the forming step (the heat treatment) of forming the oxide film 18 on the surface of the resistance body 12 by at least subjecting the resistance body 12 to the heat treatment.

With this configuration, it is possible to provide the resistor 10 in which the oxide film 18 is formed on the surface of the resistance body 12. With such a resistor 10, even if the solder approaches the resistance body 12 by flowing along each of the electrodes 14 and 16, the adhesion of the solder to the resistance body 12 is suppressed by the oxide film 18.

In addition, even in a case in which the solder reaches the resistance body 12 by flowing along each of the electrodes 14 and 16, the oxide film 18 is interposed between the solder and the resistance body 12. With such a configuration, the direct connection between the solder and the resistance body 12 is suppressed. Therefore, compared with a case in which the solder may be directly connected to the resistance body 12 at the side towards the center of the resistance body 12 with respect to the bonding positions between the resistance body 12 and each of the electrodes 14 and 16, it is possible to suppress the variation in the resistance value of the resistor 10.

Then, the resistance body 12 is protected by the surface oxide film 18. With such a configuration, because the change in the characteristics is suppressed in the resistance body 12, it is possible to maintain the resistance characteristics of the resistance body 12 over a long period of time.

In addition, according to the manufacturing method of the resistor 10 of this embodiment, in the forming step (the heat treatment), the oxide film 18 is formed on the surface of the resistance body 12 by subjecting the resistor 10 to the heat treatment.

With this configuration, as in the case in which the resistor 10 is manufactured by bonding each of the electrodes 14 and 16 to the resistance body 12, on which the oxide film 18 has been formed, it becomes unnecessary to perform an operation of removing the oxide film 18 formed on electrode bonding portions of the resistance body 12. Thus, it is possible to reduce manufacturing steps.

In addition, according to the manufacturing method of the resistor 10 of this embodiment, the resistance body 12 containing copper and manganese is subjected to the heat treatment in an atmosphere with the oxygen concentration of 30 ppm or lower at 400° C. or more and 800° C. or less, for 10 minutes or more and 300 minutes or less.

By doing so, it is possible to form the oxide film 18 on the surface of the resistance body 12. In addition, because the heat treatment is performed in the atmosphere with the oxygen concentration of 30 ppm or lower, even when the resistor 10 is subjected to the heat treatment, the formation of the oxide film on the surface of each of the electrodes 14 and 16 is suppressed.

In addition, according to the manufacturing method of the resistor 10 of this embodiment, the oxygen concentration is 5 ppm or more and 30 ppm or less.

Furthermore, according to the manufacturing method of the resistor 10 of this embodiment, the heat treatment is performed in a nitrogen atmosphere

with the oxygen concentration of 30 ppm or lower.

By doing so, the suppressing effect achieved by the oxide film formed on each of the electrodes 14 and 16 is further increased.

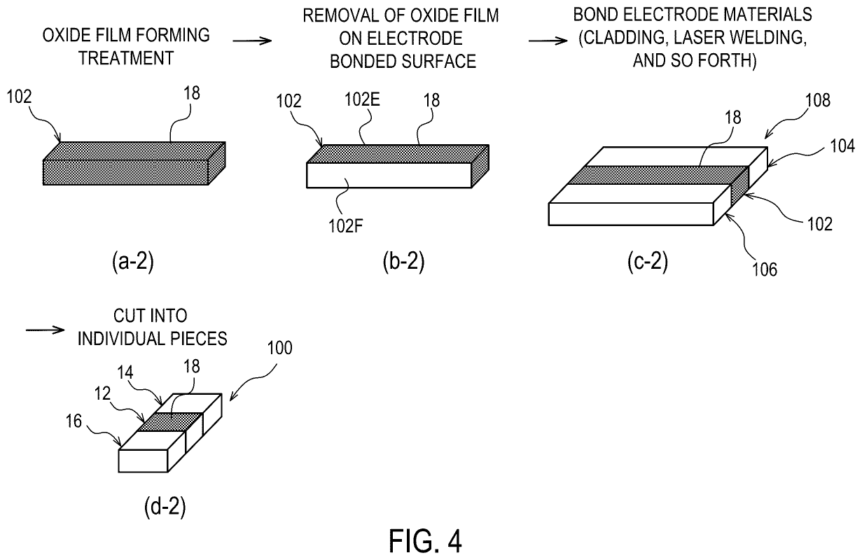

A resistor 100 according to a second embodiment will be described with reference to FIG. 4. Note that, components that are the same as or similar to those in the first embodiment will be assigned the same reference numerals as the first embodiment, and a description thereof shall be omitted. Description will only be given of components that are different from those in the first embodiment.

FIG. 4 is an explanatory diagram showing the manufacturing method of the resistor 100 of the second embodiment. The resistor 100 according to the second embodiment differs from that in the first embodiment in that the resistor 100 is formed by using the resistance body material in which the oxide film 18 is formed on the entire outer surface.

This manufacturing method includes an oxide film forming step (a-2), an oxide film removing step (b-2), the bonding step (c-2), and the singulation step (d-2). Note that, the description will be omitted for the adjusting step of adjusting the resistance value performed after the singulation step (d-2).

In the oxide film forming step (a-2), the oxide film 18 is formed on the surface of a resistance body base material 102 by subjecting the resistance body base material 102 serving as the base material of the resistance body 12 to the heat treatment. A material and the method of the heat treatment of the resistance body base material 102 are similar to those in the first embodiment.

In the oxide film removing step (b-2), the oxide films 18 formed on both of side surfaces 102E and 102F of the resistance body base material 102 are removed. A method of removing the oxide films 18 includes, for example, a machining processing.

In the bonding step (c-2), electrode base materials 104 and 106 are respectively arranged on the side surfaces 102E and 102F sides of the resistance body base material 102, from which the oxide films 18 have been removed. In this state, a pressure is applied in the arrangement direction of the base materials 102, 104, and 106 to bond each of the base materials 102, 104, and 106, and thereby, a resistor base material 108 is formed.

The respective base materials 102, 104, and 106 are bonded by a so-called cladding (the solid phase bonding), laser welding, electron beam welding, or the like between dissimilar metal materials. Note that, the material of each of the electrode base materials 104 and 106 is similar to that in the first embodiment.

In the singulation step (d-2), the resistor 100 is formed by cutting the resistor base material 108. The cutting method is similar to that in the first embodiment.

Even with the resistor 100 according to this embodiment, it is possible to achieve the operational advantages similar to those in the first embodiment.

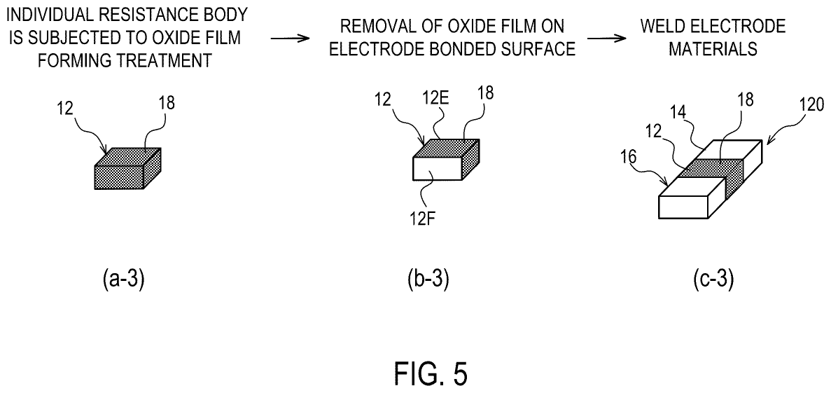

A resistor 120 according to a third embodiment will be described with reference to FIG. 5. Note that, components that are the same as or similar to those in the first embodiment will be assigned the same reference numerals as the first embodiment, and a description thereof shall be omitted. Description will only be given of components that are differ.

FIG. 5 is an explanatory diagram showing the manufacturing method of the resistor 120 of the third embodiment. The resistor 120 according to the third embodiment differs from the others in that the resistor 120 is formed by using the resistance body 12 that has been singulated and on which the oxide film 18 has been formed on the surface thereof.

This manufacturing method includes the oxide film forming step (a-3), the oxide film removing step (b-3), and the bonding step (c-3). Note that, the description will be omitted for the adjusting step of adjusting the resistance value performed after the bonding step (c-3).

In the oxide film forming step (a-3), the resistance body 12, which has been singulated in advance, is subjected to the heat treatment to form the oxide film 18 on the entire outer surface of the resistance body 12. The material and the method of the heat treatment of the resistance body 12 are similar to those in the first embodiment.

In the oxide film removing step (b-3), the oxide films 18 formed on both of the end surfaces 12E and 12F of the resistance body 12 are removed.

The method of removing the oxide films 18 includes, for example, the machining processing.

In the bonding step (c-3), the electrodes 14 and 16 are respectively arranged on the end surfaces 12E and 12F sides of the resistance body 12, from which the oxide films 18 have been removed. In this state, the first electrode 14 and the resistance body 12 are bonded together, and the second electrode 16 and the resistance body 12 are bonded together to form the resistor 120.

A method of bonding includes the laser welding, the electron beam welding, and so forth. Note that, the material of each of the electrodes 14 and 16 is similar to that in the first embodiment.

Even with the resistor 120 according to this embodiment, it is possible to achieve the operational advantages similar to those in the first embodiment.

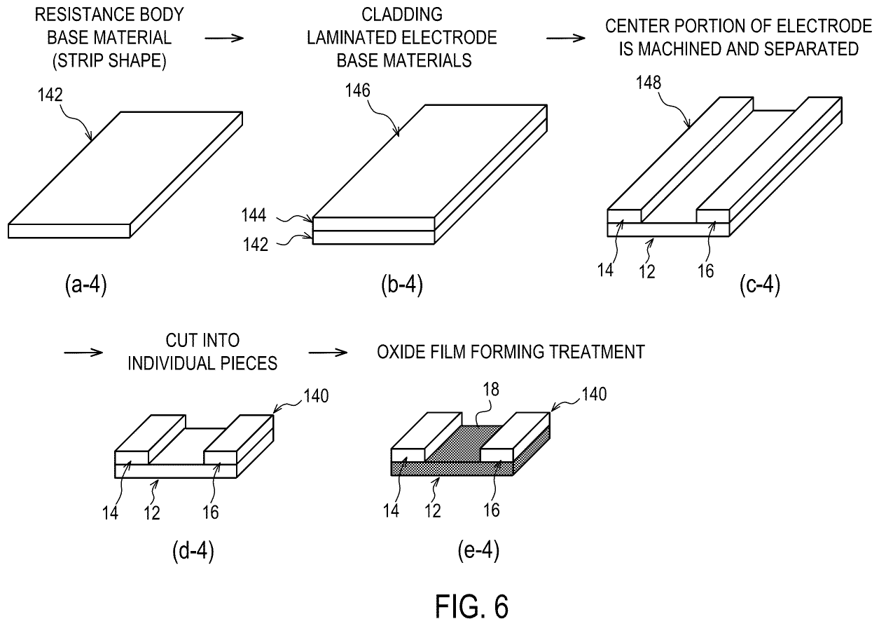

A resistor 140 according to a forth embodiment will be described with reference to FIG. 6. Note that, components that are the same as or similar to those in the first embodiment will be assigned the same reference numerals as the first embodiment, and a description thereof shall be omitted. Description will only be given of components that are differ.

FIG. 6 is an explanatory diagram showing the manufacturing method of the resistor 140 of the forth embodiment. The resistor 140 according to the forth embodiment differs from the others in that the first electrode 14 and the second electrode 16 are formed by performing machining of an electrode base material 144 that is laminated on a resistance body base material 142.

This manufacturing method includes the preparation step (a-4) of preparing the resistance body base material 142 having a plate shape, the bonding step (b-4) of bonding the electrode base material 144 having the plate shape to the resistance body base material 142, and a machining step (c-4) of performing machining of the electrode base material 144. In addition, the manufacturing method includes a cutting step (d-4) of cutting a resistor base material 148 that has been subjected to the machining, and the oxide film forming step (e-4) of forming the oxide film 18 on the resistance body 12 of the resistor 140 that has been cut. Note that, the description will be omitted for the adjusting step of adjusting the resistance value performed after the oxide film forming step (e-4).

In the preparation step (a-4), the resistance body base material 142 having the plate shape (the strip shape) is formed. The material of the resistance body base material 142 is similar to that in the first embodiment.

In the bonding step (b-4), the electrode base material 144 having the plate shape is arranged over the resistance body base material 142. In this state, a pressure is applied to the laminated direction of both of the base materials 142 and 144 to bond both of the base materials 142 and 144, and thereby, a bonded base material 146 is formed.

Both of the base materials 142 and 144 are bonded by a so-called cladding (the solid phase bonding) between the dissimilar metal materials. Note that, the material of the electrode base material 144 is similar to that in the first embodiment.

In the machining step (c-4), the center portion of the electrode base material 144 is machined to form the resistor base material 148. In the resistor base material 148, the first electrode 14 is formed on the one side by taking the machined portion as a boundary, and the second electrode 16 is formed on the other side thereof.

In the cutting step (d-4), the resistor 140 is formed by cutting the resistor base material 148 into a predetermined length. The cutting method is similar to that in the second embodiment, for example.

In the oxide film forming step (e-4), the resistor 140, which has been cut, is subjected to the heat treatment, and thereby, the oxide film 18 is formed only on the surface of the resistance body 12. The method of the heat treatment is similar to that in the first embodiment.

Even with the resistor 140 according to this embodiment, it is possible to achieve the operational advantages similar to those in the first embodiment.

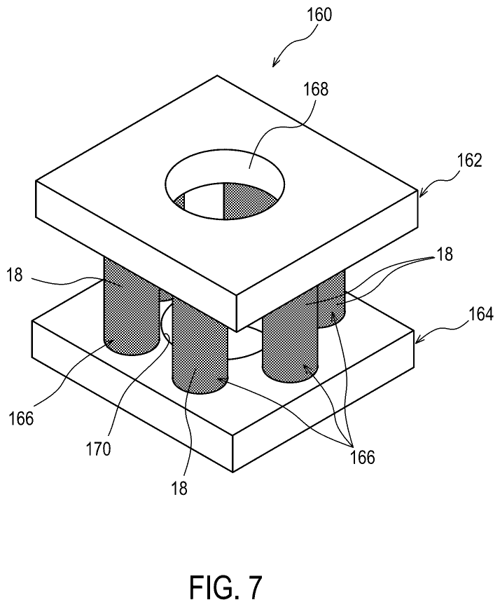

A resistor 160 according to a fifth embodiment will be described with reference to FIG. 7. Note that, components that are the same as or similar to those in the first embodiment will be assigned the same reference numerals as the first embodiment, and a description thereof shall be omitted. Description will only be given of components that are differ.

FIG. 7 is a perspective view of a resistor 150 of the fifth embodiment. The resistor 160 according to the fifth embodiment differs from the other embodiments in that a plurality of resistance bodies 166 are arranged between a first electrode 162 and a second electrode 164 so as to be separated from each other.

The first electrode 162 and the second electrode 164 are formed of the material similar to that in the first embodiment. Each of the electrodes 162 and 164 is formed to have a square plate shape, and circular through holes 168 and 170 are respectively formed in the center portions of the electrodes 162 and 164.

The plurality of resistance bodies 166 are provided between both of the electrodes 162 and 164, and the number of the resistance bodies 166 can be set arbitrarily. The resistance bodies 166 are respectively arranged at equal intervals on a concentric circles about the through holes 168 and 170, and end portions of each of the resistance bodies 166 are respectively bonded by welding, for example, to the corresponding electrodes 162 and 164. With such a configuration, the respective resistance bodies 166 are connected in parallel.

Each of the resistance bodies 166 is formed to have a cylindrical shape, and the material of each of the resistance bodies 166 is similar to the material in the first embodiment. The oxide film 18 is formed on a peripheral surface of each of the resistance bodies 166 by the heat treatment described above.

Note that, the shape of each of the electrodes 162 and 164 is not limited to this quadrangle shape, and it may be a polygonal shape such as a triangle shape or a circular shape. In addition, the shape of the through holes 168 and 170 is not limited to a circular shape, and it may be a polygonal shape such as a quadrangle shape.

Even with the resistor 160 according to this embodiment, it is possible to achieve the operational advantages similar to those in the first embodiment. Note that, although the oxide film 18 is formed on the peripheral surface of all of the resistance bodies 166 in this embodiment, the oxide film may be formed only on the peripheral surface of a part of the resistance bodies 166 in accordance with the use environment of the resistor.

Although the embodiments of the present disclosure have been described in the above, the above-mentioned embodiments merely illustrate a part of application examples of the present disclosure, and the technical scope of the present disclosure is not intended to be limited to the specific configurations of the above-described embodiments.

The resistor 10 according to the first embodiment was subjected to the heat treatment under respective conditions, and a formation state of the surface oxide film of each of the electrodes 14 and 16 and the resistance body 12 of the obtained resistor 10 was evaluated.

As the resistance body material forming the resistance body 12 of the resistor 10, the Cu—Mn—Sn based resistive material was used. In other words, the resistance body material contained 10 to 12 mass % of manganese, 1 to 4 mass % of nickel, and 84 to 89 mass % of copper by the total mass ratio of the resistance body material.

The resistor 10 was subjected to the heat treatment in an atmosphere with the oxygen concentration of 30 ppm or lower by maintaining a predetermined temperature of 200° C. or more and 800° C. or less, for a predetermined period of 1 hour (60 minutes) or more and 5 hours (300 minutes) or less. For each of the resistors 10 subjected to the heat treatment, the states of the respective surfaces of the electrodes 14 and 16 and the resistance body 12 were observed. The results are shown in Table 1.

Note that, it was determined whether the formed oxide film was “Mn3O4” or “MnO” by using X-ray analyzer.

TABLE 1

| | 1 Hr | | 3 Hr | | 5 Hr | |
|---|---|---|---|---|---|---|
| 200° C. | | | | | Elec- | Resistance |
| | | | | | trode | body |
| | | | | | non | non |
| 400° C. | Elec- | Resistance | Elec- | Resistance | Elec- | Resistance |
| | trode | body | trode | body | trode | body |
| | non | Mn₃O₄ | non | Mn₃O₄ | non | Mn₃O₄ |
| 600° C. | Elec- | Resistance | Elec- | Resistance | Elec- | Resistance |
| | trode | body | trode | body | trode | body |
| | non | MnO | non | MnO | non | MnO |

| | | | | |
|---|---|---|---|---|
| 800° C. | Elec- | Resistance | Elec- | Resistance |
| | trode | body | trode | body |
| | non | MnO | non | MnO |

As shown in Table 1, with the resistor 10 subjected to the heat treatment in which the resistor 10 was kept at 200° C. for 5 hours, the oxide film 18 was not formed on the resistance body 12 and each of the electrodes 14 and 16.

In addition, with any of the resistors 10 subjected to the heat treatment in which the resistor 10 was kept at 400° C. for 1 hour, the heat treatment in which the resistor 10 was kept at 400° C. for 3 hours, and the heat treatment in which the resistor 10 was kept at 400° C. for 5 hours, the formation of the oxide film 18 of manganese (Mn3O4) on the resistance body 12 was confirmed. On the other hand, with any of the respective electrodes 14 and 16 of the resistors 10 subjected to the heat treatment in which the resistor 10 was kept at 400° C. for 1 hour, the heat treatment in which the resistor 10 was kept at 400° C. for 3 hours, and the heat treatment in which the resistor 10 was kept at 400° C. for 5 hours, the formation of the oxide film could not be confirmed.

In addition, with any of the resistors 10 subjected to the heat treatment in which the resistor 10 was kept at 600° C. for 1 hour, the heat treatment in which the resistor 10 was kept at 600° C. for 3 hours, and the heat treatment in which the resistor 10 was kept at 600° C. for 5 hours, the formation of the oxide film 18 of manganese (MnO) on the resistance body 12 was confirmed. On the other hand, with any of the respective electrodes 14 and 16 of the resistors 10 subjected to the heat treatment in which the resistor 10 was kept at 600° C. for 1 hour, the heat treatment in which the resistor 10 was kept at 600° C. for 3 hours, and the heat treatment in which the resistor 10 was kept at 600° C. for 5 hours, the formation of the oxide film could not be confirmed.

In addition, with any of the resistors 10 subjected to the heat treatment in which the resistor 10 was kept at 800° C. for 1 hour, and the heat treatment in which the resistor 10 was kept at 800° C. for 3 hours, the formation of the oxide film 18 of manganese (MnO) on the resistance body 12 was confirmed. On the other hand, with any of the respective electrodes 14 and 16 of the resistors 10 subjected to the heat treatment in which the resistor 10 was kept at 800° C. for 1 hour, and the heat treatment in which the resistor 10 was kept at 800° C. for 3 hours, the formation of the oxide film could not be confirmed.

By forming the oxide film 18 on the resistance body 12 as described above, the resistance body 12 is protected, and suppression of the change in the characteristics as the resistor 10 is expected.

Next, each of the resistors 10, in which the oxide film 18 of manganese was formed on the resistance body 12, was mounted on the circuit board, and the electrodes 14 and 16 of each of the resistors 10 were respectively soldered to the lands of the wiring pattern, and then, a state of the adhesion of the solder to the resistance body 12 was visually observed. As a result, it was found that the effect varies depending on the formation state of the oxide film 18.

Specifically, with the resistors 10 subjected to the heat treatment in which the resistor 10 was kept at 600° C. for 5 hours (a resistor made for the experiment) and the heat treatment in which the resistor 10 was kept at 800° C. for 1 hour, the effect of suppressing the adhesion of the solder to the resistance body 12 was extremely favorable.

It is considered that these results related to the film thickness of the formed oxide film 18. Based on these results, in a case in which the heat treatment is performed at a lower temperature, the oxide film 18 is formed to have the desired film thickness by performing the heat treatment over a longer period of time.

In addition, in a case in which the heat treatment is performed at a higher temperature, it is possible to reduce the heat treatment time required to form the oxide film 18 with the desired film thickness. On the other hand, if the heat treatment time is too long, because the formation of the oxide film 18 on each of the electrodes 14 and 16 is facilitated, it is preferable that the heat treatment time be set within a predetermined time.

1. A resistor comprising a resistance body and electrodes provided on the resistance body, wherein
the resistance body has an oxide film on a surface.

2. The resistor according to claim 1, wherein
the resistance body is configured so as to contain a metal for the resistance body, and
the electrodes are configured so as to contain a metal having a lower specific resistance than the resistance body.

3. The resistor according to claim 2, wherein
the metal for the resistance body contains manganese, and
the oxide film of manganese is formed on the surface of the resistance body.

4. The resistor according to claim 2, wherein the oxide film contains MnO or Mn3O4.

5. A manufacturing method of a resistor, the resistor comprising a resistance body and electrodes provided on the resistance body, wherein the manufacturing method having a forming step of forming an oxide film on a surface of the resistance body by at least subjecting the resistance body to a heat treatment.

6. The manufacturing method of the resistor according to claim 5, wherein in the forming step, the oxide film is formed on the surface of the resistance body by subjecting the resistor to the heat treatment.

7. The manufacturing method of the resistor according to claim 5, wherein the resistance body containing copper and manganese is subjected to the heat treatment in an atmosphere with an oxygen concentration of 30 ppm or lower at 400° C. or more and 800° C. or less, for 10 minutes or more and 300 minutes or less.

8. The manufacturing method of the resistor according to claim 7, wherein the oxygen concentration is 5 ppm or more and 30 ppm or less.

9. The manufacturing method of the resistor according to claim 7, wherein the heat treatment is performed in a nitrogen atmosphere with the oxygen concentration of 30 ppm or lower.

10. The manufacturing method of the resistor according to claim 6, wherein the resistance body containing copper and manganese is subjected to the heat treatment in an atmosphere with an oxygen concentration of 30 ppm or lower at 400° C. or more and 800° C. or less, for 10 minutes or more and 300 minutes or less.

11. The manufacturing method of the resistor according to claim 8, wherein the heat treatment is performed in a nitrogen atmosphere with the oxygen concentration of 30 ppm or lower.
